(19) United States
(12) Patent Application Publication
(10) Pub. No.: US 2021/0110416 A1
(43) Pub. Date: Apr. 15, 2021

(54) ANALYTICS SYSTEM AND METHOD FOR BUILDING AN AUTONOMOUS VEHICLE DEPLOYMENT READINESS MODEL FOR A GEOGRAPHIC AREA

(71) Applicant: cg42 LLC, Isle of Palms, SC (US)

(72) Inventors: Stephen Beck, New York, NY (US); Dan Mathis, New York, NY (US)

(21) Appl. No.: 17/067,343

(22) Filed: Oct. 9, 2020

Related U.S. Application Data
(60) Provisional application No. 62/914,245, filed on Oct. 11, 2019.

(51) Int. Cl. G06Q 30/02; G06Q 50/30

(52) U.S. Cl. CPC G06Q 30/0205; G05D 1/0287; G06Q 50/30; G06Q 30/0201

(57) ABSTRACT

An automated computerized system and method that evaluates and determines readiness of multiple geographic locations for employment of autonomous vehicles. The system receives and analyzes input data for the locations based on evaluation of (a) weather constraint data, (b) population size constraint data, and (c) speed limit constraint data. In the next phase, it evaluates and applies (1) total food related delivery vehicles data, (2) total ride hail vehicles data, (3) historic growth rate for each type of vehicle; and (4) turnover rate for each type of vehicle. In the next phase, the system evaluates and applies (i) economic indicators, (ii) city transportation indicators, and (iii) city operator metrics. After processing and automatically combining and evaluating the data based on the constraints and indicators of the various phases, the system computes the resulting values, indicating readiness for the deployment of automated vehicles and projected implementation timeline for the multiple locations and provides the result for use in implementing the AV readiness programs at the researched locations.

### REFERENCE TO RELATED APPLICATION

This application claims priority to U.S. Provisional Patent Application No. 62/914,245, filed Oct. 11, 2019, the entire disclosure of which is incorporated herein by reference.

### FIELD OF THE INVENTION

The present invention generally relates to use of autonomous vehicles and, more particularly, to automated computerized analytics systems and methods that mathematically determine and score a particular geographic area or city's readiness for employing autonomous vehicles for various uses, as well as projects implementation forecasts, and provides comparative analysis for different areas/cities. The resulting analysis, automatically determined valuations and conclusions determine the order of implementation, feasibility and the decision for utilization of autonomous vehicles in different areas or cities.

### BACKGROUND

In recent years, use of autonomous or semi-autonomous vehicles (or modes on a regular driver operated vehicles) has become popular in the automotive industry. Autonomous vehicles, such as autonomous automotive land driven vehicles, can be used to streamline transportation of people and goods to desired locations. Typically, the autonomous automotive vehicles, or manual vehicles equipped with an semi-autonomous operational mode, include sensors (e.g., a Global Positioning System (GPS) sensor, a global timer sensor, a Light Detection and Ranging (LIDAR) sensor, cameras, radar sensor, etc.) that generate data on the environment in which the vehicles are operating. The vehicles also include on-board computerized systems that process the data generated by the sensors and generate visual perspective and data pertaining to the environments in which the vehicles are operating. The perspective and data related to the environments is processed by the on-board computerized system and assist the autonomous automotive vehicles in navigating the environments.

One of the obstacles to the global acceptance of the autonomous or semi-autonomous vehicles or regular vehicles with such modes is the ability to determine which geographic locations or cities are best suited for the adoption of such vehicles, and to have an automated model for predicting the use and growth of such vehicles in a particular location. The automated predicted growth and feasibility model provides data and information that determines the order for implementation and utilization of autonomous vehicles, and also determine whether and when the autonomous vehicle use is suited for a particular geographic location or locations.

While known projections for volumes of autonomous vehicles are generally optimistic, they provide little to no information or insight on which use cases would have greatest volume potential and which markets (i.e. cities) would be best suited for autonomous vehicle adoption. Furthermore, available projections do not realistically capture the available opportunity associated with replacing current commercial fleets or the economic cost of removing a vehicle before it was to retire.

### SUMMARY OF THE INVENTION

Various aspects, objectives and features of the present invention, in at least one embodiment, entails an automated computerized system that allows projective modeling and determination of the most realistic addressable volume of vehicles that could be made autonomous in a given city in a given year. To arrive at this metric, the automated computerized model utilizes at least one computer processor, with memory and Internet access capability to execute at least one computer program that creates and processes the instructions that create a specific model and calculate the results (“Readiness Model”). The model automatically calculates and determines the most realistic addressable volume of vehicles that could be made autonomous in a given city or geographic location, in a given year, as well as providing projections for subsequent years.

In at least one embodiment, the computerized system implementing the Readiness Model may assume that only vehicles that are being replaced in a given year are addressable for autonomous vehicle substitution. For example, if a taxi has reached its lifespan and a new one is being put into the city's taxi fleet, that taxi is considered addressable by the model. Taxis that are in service and are within their normal lifespan are not included in the projections (not subject to replacement by an autonomous or semi-autonomous vehicle).

Given technology commercialization dynamics (among other factors), the present model determines that it would be unreasonable to assume that non-autonomous vehicles with life left in their lifespan would be removed from service to be replaced by autonomous vehicles. Furthermore, the Readiness Model utilizes and considers specific partners to best identify potential high-volume business relationships to pursue across cities or geographic areas.

At least one implementation of the Readiness Model may process and create models and provide automated readiness result calculations for multiple cities or geographic location for comparison and to prioritize implementation of the autonomous vehicles in the cities where such utilization would lead to wider acceptance and larger volume of growth, as well as other factors that are utilized in the modeling and evaluation process by the computerized programs implementing the present invention.

The Readiness Model in at least one embodiment may also consider economic indicators, traffic congestion metrics, personal urban vehicle miles travelled to understand where autonomous vehicles could have the largest impact given the congestion reduction and potential ride sharing benefits of a fleet of autonomous vehicles.

As part of an engagement to understand the near-term opportunity associated with autonomous vehicles, the Readiness Model of at least one embodiment addresses and evaluates a clear gap in the current industry perspective and acceptance process.

Among other features and benefits, the Readiness Model addresses the gaps and deficiencies of the known systems and incorporates into the computerized model and calculations inputs from various governmental, regulatory bodies, think tanks, industry perspectives, and primary research to gauge the economic, technological, and demand readiness of individual cities across the US, Europe, and Asia.

This model, in at least one embodiment, applies technology adoption curves and adoption rates to further quantify the associated autonomous vehicle opportunity over a 9-year time horizon for multiple (100+) cities. The automated model and processing performed in accordance with the Readiness Model of the present invention is not limited to any particular time duration (the 9-year prediction was just one example), and may use fewer or more cities or geographic locations for comparison.

The cities or geographic locations used in the Readiness Model may be those that were examined for commercial fleet applications ranging from autonomous logistics delivery to ride hailing/ride sharing, and model both current fleets, as well as projected growth, based on the city-specific market trends and dynamics. The data-points resulting model calculations and evaluations may be used to prioritize cities for AV deployment based on the volume opportunities to pursue, as part of a go-to-market plan, and including partnership identification and pilot requirements. In other words, the results of the automated processing may determine the order of utilization of automated vehicles in different locations.

In order to address and resolve some of the problems in prior art and the needs for a more efficient and enhanced solution, the present invention may implement an automated computerized system, with computer processors executing specific computer instructions, or a method that first receives and analyzes input data for the multiple geographic locations based on evaluation of a (a) weather constraint data, (b) population size constraint data, and (c) speed limit constraint data, as part of the first phase of analysis.

In the next phase, it may evaluate and apply a (1) total food related delivery vehicles data, (2) total ride hail vehicles data, (3) historic growth rate for each type of vehicle and (4) turnover rate for each type of vehicle. In the next phase, the system evaluates and applies (i) economic indicators, (ii) city transportation indicators, and (iii) a city operator metrics, as part of the second phase of analysis.

After processing and automatically combining and evaluating the data based on the constraints and indicators of the first, second and third phases, the system computes the resulting values, indicating readiness for the deployment of automated vehicles and a projected implementation timeline for the multiple locations and provides the result for use in implementing the AV readiness programs at the researched locations.

In at lest one embodiment, the system may base the evaluations of the weather constraint data based on whether the evaluated locations have higher percentage of days without heavy rain, heavy snow, or fog, based on one or more weather data sources. Similarly, the evaluation of the population constraint data may involve determining locations with higher concentration of human population per square mile and an overall population greater than a minimal set limit, based on one or more census data sources. The evaluation of the speed limit constraint data may involve determining wherein at least 90 percent of speed limitations zones within the location are below 45 miles an hour, or are typically travelled by cars at lower than 45 miles an hour.

The number of evaluated cities or geographic locations may be reduced after the first or second phase of processing, to make the system operate more efficiently.

In at least some embodiments, the system and method may evaluate the food related delivery vehicles data, which pertains to a grocery, a restaurant, a local and a last mile delivery vehicles, and the delivery vehicles data pertains to data for a plurality of vehicles that deliver groceries from multiple food stores and supermarkets. The last-minute vehicles data may be based on or utilize a market share of UPS, FedEx, DHL, Amazon and other regional delivery services.

In at least some embodiments, the system and method may utilize and evaluate the ride hail vehicles data pertaining to taxis, TaaS vehicles, limousines and other passenger vehicles, and public transportation that carry multiple passengers. It may also evaluate the already present (or soon to be employed autonomous vehicles), and assign an estimated life span of 4 years to those vehicles. The system and method may also calculate the turnover rate for at least one type of vehicle that is calculated based on a number of vehicles of the same or similar type that are replaced each year.

In at least some embodiments, the system and method may further determine and apply the economic indicators, which may be based on the data and analysis of a luxury goods sales and a local shopping sales. The city transportation constraints utilized by the system may apply data and analysis of a vehicle miles travelled, a public transport share of travel and an added travel time from a congestion data and evaluation at the location. The determining and applying the city operator metrics may include applying data and analysis of a number of taxi companies and a number of local delivery companies at the analyzed geographic location.

Various other features and benefits of the present invention will become readily apparent to those of ordinary skill in the art from the following detailed description of the invention

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 illustrates a general structure, organization and operation of Phase 1, the city selection process for the US market and the binary selection process based on such factors as speed, weather, and population density metrics for a given city or geographic area, and for determining whether to include the evaluated city (or cities) or a geographic area in the Phase 2 analysis in accordance with at least one embodiment.

FIG. 2 illustrates a general structure, organization and operation of Phase 2, the city prioritization process for the US market, and how the autonomous vehicle volume opportunities are calculated each year for a given city or a geographic area in accordance with at least one embodiment.

FIG. 3 illustrates a model input for Phase 2, the city prioritization process for the US market in accordance with at least one embodiment.

FIGS. 4A-B illustrate model output for Phase 2, the city prioritization process for the US market based on the inputs shown in FIG. 3, as well as cumulative opportunity over the 9-year period in accordance with at least one embodiment.

FIG. 5 illustrates the modeling factors and process for the analysis of city or geographic area readiness for the autonomous vehicle deployment in accordance with at least one embodiment.

FIG. 6 illustrates a project delivery plans and an estimated delivery of autonomous vehicles for a city or geographic area based on the urban metropolitan statistical area core population in accordance with at least one embodiment of the present invention.

### DETAILED DESCRIPTION

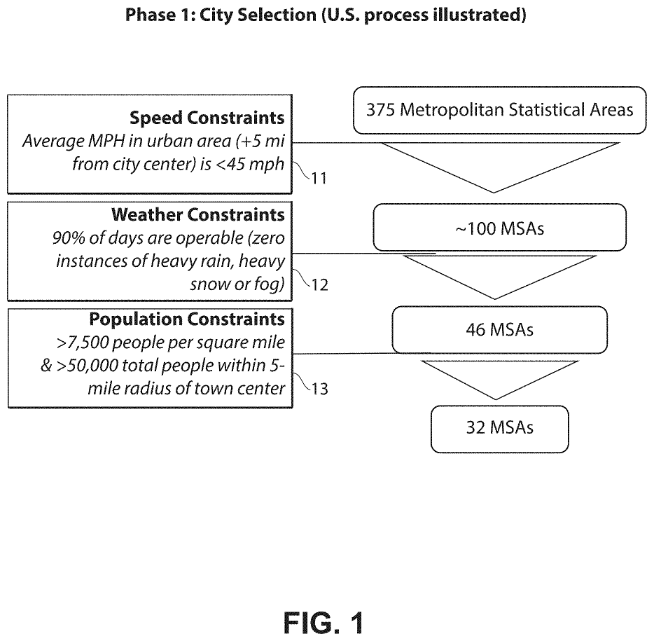

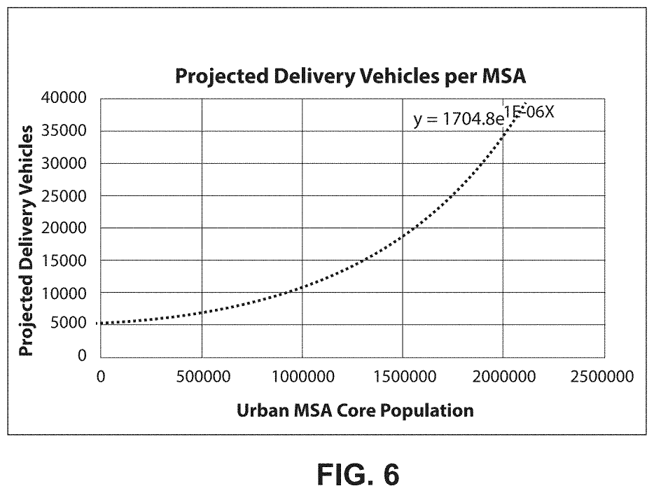

The description of multiple phases of the automated Readiness Model evaluation in accordance with one or more examples is provided below with reference to FIGS. 1-6. The examples of various analysis and results generated utilizing the Readiness Model evaluation embodiment(s) of the present invention are provided in Appendix A.

Phase 1—City Selection

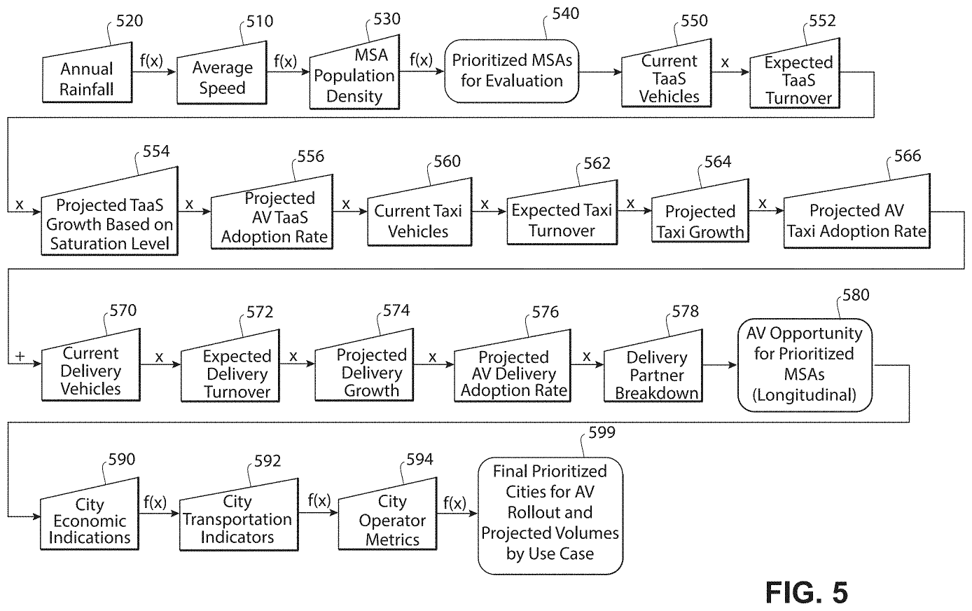

In the first phase (Phase 1), a computerized system utilizes one or more processors that execute compute instructions (stored in computer memory) to model and automatically evaluate the Readiness Model for all metropolitan statistical areas (MSAs) on a binary basis (go/no-go criteria). In at least one embodiment, there are three main criteria that define if a city (or geographic area) should be further evaluated and go through the prioritization and market dynamics phases. As illustrated in FIGS. 1 and 5, the evaluated constrains that are evaluated by the computer processor executing the computer instruction that implement the Readiness Model (in accordance with one or more inventions) may include automated evaluation and analysis of: (1) weather constraints (12 in FIGS. 1 and 520 in FIG. 5); (2) population size constraints (13 in FIGS. 1 and 530 in FIG. 5); and (3) speed limits constraints (11 in FIGS. 1 and 510 in FIG. 5).

(1) Weather—early versions of autonomous vehicles are assumed to not be able to function (or too risky to operate) on days of heavy rain, heavy snow, and fog due to lidar constraints. To account for this, in one or more embodiments, the Readiness Model evaluates only the cities or geographic locations with high percentage (ex. 90%+) days without heavy rain, heavy snow, or fog, as classified by Weather Source. Thus, only the locations that are determined to have a large number of days without rain, snow or fog are considered further in the automated analysis. In one or more embodiments, the geographic locations with poor weather conditions are cut off from the analysis and are rejected or placed at the lower priority and feasibility for AV deployment. This automated cut-off (or constraint) allows for more efficient analysis and processing of multiple locations that are better suited for the AV deployment in terms of weather conditions.

(2) Population Size and Density—in order to have a viable business opportunity, in accordance with one or more embodiments, only cities with greater than X (for example, 7,500) people per square mile and over Y (for example, 50,000 total) population within Z-mile (for example, 5-mile) radius of town hall may be further considered in the modeling and further processing. In some embodiment, the data can be taken from the 2010 or later U.S. Census Bureau publications. This automated cut-off (or constraint) allows for more efficient analysis and processing of multiple locations that have the necessary population and population density that are better suited for the AV deployment particularly, in processing and evaluation of multiple geographic locations.

(3) Travel/Maximum Speed—due to lidar or legal constraints, early autonomous vehicles cannot travel safely faster, or not permitted to travel faster, than at the speed of 45 MPH. In at least one embodiment, only cities or geographic areas that are further considered in the analysis are areas where the 90^{th} percentile speed limit within Metropolitan Statistical Area (MSA) is not greater than 45 MPH. In one embodiment, the vehicle trace data and speed limit data can be taken from Zubie for March 2016 (or later) and used for this analysis. This automated cut-off (or constraint) allows for more efficient analysis and processing of multiple locations that have lower speed limits that can accommodate the lidar, legal or other constraints on the utilization and AV deployment, and avoid the analysis of high speed geographic areas that are poorly suited for AV deployment, where the AV speed is limited to 45 MPH.

The application of the weather, population and speed limit constraints to a list of 375 U.S. Metropolitan Statistical Areas (MSAs) is shown in FIGS. 1 and 5. By applying the speed constraints 11 (also shown as 510 in FIG. 5) the list of 375 MSA may be reduced by −100. Application of the subsequent weather constraints 12 (also shown as 520 in FIG. 5) would reduce the number of possible MSA to 46, and the application of the population constraints 13 (also shown as 530 in FIG. 5) may further reduce the list of MSA to 32.

Phase 2—City Prioritization

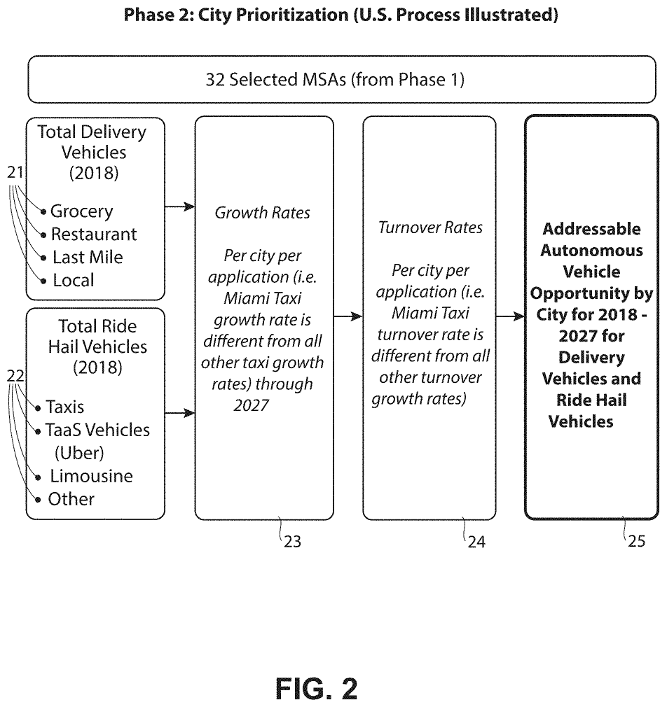

Once relevant cities (or geographic areas) have been selected (or have passed the automatic application of constraints and cut off limits) in phase 1, the Readiness Model evaluates and processes the selected geographic locations though the prioritization phase (Phase 2). As shown in FIGS. 2 and 5, the following aspects of a city's vehicle volumes 22 are incorporated and automatically evaluated (ex., setting for 2016): (a) taxis; (b) TaaS vehicles; (c) food delivery; (d) grocery delivery; (e) limousines; (f) last minute delivery vehicles; and (g) shuttle buses.

(a) Taxis (22 in FIGS. 2 and 560 in FIG. 5)—registered taxis in the city's urban core are included in the volume determination of the prioritization phase. Data regarding number of active taxis in an area can be obtained from the local taxi and limousine commission.

(b) TaaS (22 in FIGS. 2 and 550 in FIG. 5)—registered transportation-as-a-service vehicles (i.e. Uber, Lyft, etc.). Data obtained from the local taxi and limousine commission, where available. If this data was not readily available, a regression based on available data for other cities was used. Each city was classified as either “saturated” with TaaS vehicles (Uber or Lyft has operated in that city for 5+ years) or “unsaturated” with TaaS vehicles. A regression formula is built for each type of city, correlating population size with number of TaaS vehicles. Accordingly, the city's population without available data was put through the regression and an assumed TaaS volume was assigned.

(c) Food Delivery (21 in FIG. 2)—number of vehicles delivering food from restaurants. Based on prior reports on the industry, the analysis may assume that each restaurant has certain number (for example, 3) delivery vehicles, and food delivery-based vendors, like Domino's, have more (for example, 4) delivery vehicles. Using registered restaurant data from individual city databases, certain volumes can be assumed and used in calculations for each city or geographic area.

(d) Grocery Delivery (21 in FIG. 2)—number of vehicles delivering groceries from a supermarket. Based on data available from grocery delivery services Postmates and Instacart, it can be assumed that each supermarket supplies ten vehicles. (Different set numbers can also be used when supported by historical data). Using registered business license data from individual city databases, certain volumes can be assumed and used in calculations for each city or geographic area.

(e) Limousines (22 in FIG. 2)—registered limousine/black cars in the city's urban core. Data can be obtained from the local taxi and limousine commission.

(f) Last Mile Delivery vehicles (21 in FIG. 2)—local delivery vehicles in an urban core. These vehicles are designed for final delivery of packages to consumers and businesses. Based on available information for 5 cities, a regression was built to find the correlation between delivery vehicle volumes and registered local delivery drivers from the Bureau of Labor Statistics for the MSA. Once the regression equation was built, each MSA's registered local delivery drivers metric was used to assume the volume of delivery vehicles.

(g) Shuttle Buses (22 in FIG. 2)—vehicle volumes for van-like shuttles used to move people around a city. Based on population size and density, the number of shuttles per city was assumed.

In at least one embodiment, the volumes used in the determination can be taken for the year 2016. The Readiness Model assesses volumes over a 9-year period and therefore requires growth rates for each individual use case.

Referring to FIGS. 2 and 5, in at lest one embodiment, the growth rates 23 in FIG. 2 for each type of vehicle may be calculated as follows:

a) Taxis (shown as 564 in FIG. 5)—historical growth rates of taxis in each city, for example, using 2006-2016 as the time horizon for analysis;

b) TaaS (shown as 554 in FIG. 5)—assumed growth rates varied by length of time a TaaS service had been present in a given city. For example, if a service (i.e. Uber) had been present for 5+ years, the growth rates can be assumed to be 7% based on the historical data. If the city did not have a TaaS service or had it for fewer than 5 years, the growth rate can be assumed to be 20% yoy.

c) Food Delivery—the growth rate of the food delivery services can be utilized by the system in one or more embodiments. For example, the automated analysis can utilize the growth rate based on corresponding growth rates of Seamless, Eat24, and Postmates services.

d) Grocery Delivery—the growth rate of the grocery delivery services for supermarkets and online supermarket purchasing platforms can be utilized by the system in one or more embodiments. For example, the automated analysis can utilize the growth rate based on corresponding growth rates of Instacart and Whole Foods. The calculation and use of the projected Food and Grocery Delivery Growth rate 574 is shown in FIG. 5.

e) Limousine—historical growth rates of limousines in each city, using 2006-2016 as the time horizon for analysis.

f) Last Mile Delivery vehicles—historical e-commerce growth rates were the basis for the assumed growth rate of last mile delivery.

g) Shuttle Bus—historical growth rates of shuttles in each city, using 2006-2016 as the time horizon for analysis.

Each of these volume opportunities may then multiplied by an annual turnover rate 24 in FIG. 2 for each type of vehicle (the number of vehicles replaced each year from the fleet). In one example, the following rates have been utilized in the automated calculations:

a) Taxis (shown as 562 in FIG. 5)—historical turnover rates from New York City, Los Angeles can be used as proxies for all city (and areas) assumptions.

b) TaaS (shown as 552 in FIG. 5)—turnover rate mirrored taxis, given that annual vehicle miles travelled is relatively consistent for both groups.

c) Food Delivery—can be based on average vehicle miles travelled by one or more Dominos delivery vehicles.

d) Grocery Delivery—can be based on an average vehicle miles travelled by one or more Dominos delivery vehicles. Use of the projected Food and Grocery Delivery turnover rate is shown as 574 in FIG. 5.

e) Limousine—IBIS World limo report set average lifespan for a limousine at 3 years, and this estimate may be used in calculations.

f) Last Mile Delivery vehicles—blended average of lifespan for delivery truck (for example, from the UPS data about delivery trucks) and delivery van (for example, the DHL data about delivery vans).

g) Shuttle Bus—in one example, the same turnover rate was assumed as for limousines.

All autonomous vehicles may be assumed to have a 4-year lifespan and re-plated accordingly.

Finally, the Readiness Model examined individual partners in each of the use case areas for delivery and ride hailing. For example, the following partners and their corresponding shares may be considered in the Readiness Model in accordance with at least one embodiment:
UPS—market share of last mile delivery across US, APAC, and EU
FedEx—market share of last mile delivery across US, APAC, and EU
DHL—market share of last mile delivery across US, APAC, and EU
Amazon—assumptions validated by Amazon reports
Other Regional Delivery—remainder of vehicles left on road
Uber—market share across regions (Uber was substituted by regional players in APAC and EU, such as Didi and Kareem)
Dominos—assumed 4 cars per store in each city
Whole Foods—assumed 10 cars per store in each city

As shown in FIG. 2, the output of this phase may be the volume potentials (addressable autonomous vehicle opportunity) across each of these use case areas by year and cumulatively over a 9-year period.

Phase 3—City Market Dynamics

In some embodiments, other additional indicators may be incorporated into the model and used in the automated calculations, to provide nuance for the opportunity in Phase 3 of the City Readiness Model. These indicators were based primarily in the following three categories: (1) Economic indicators (shown as 590 in FIG. 5); (2) City Transportation indicators (shown as 592 in FIG. 5) and (3) Number of operators (city operator metrics) for ride hail and delivery companies (shown as 594 in FIG. 5).

(1) Economic Indicators (590)—given that autonomous vehicles will come at a price premium, ensuring a city has a strong economy will be important. The following factors may be further considered and included in the model as part of the Economic Indicators (590), in accordance with at least one embodiment:

a. Luxury Goods sales. The reason to include this factor in the model for AV vehicles is because luxury users tend to be early adopters of new technology and are willing to pay for convenience.

b. Local Shopping sales. The reason to include this factor in the model for AV vehicles is because most delivery will occur in local situations so strong local sales are important precursors for autonomous delivery services.

(2) City Transportation (592)—a city with higher needs for delivery and ride hailing fleets will be more likely to adopt autonomous vehicles. The following factors may be further considered and included in the model in accordance with at least one embodiment as part of the Citi Transportation (592):

a. VMT travelled—the more vehicle miles traveled in a city, the more movement is available to be replaced by autonomous vehicles.

b. Public Transport share—lower public transportation use means more individuals using ride hail services today and more likely to use new services.

c. Added Travel Time from Congestion—given autonomous vehicle benefits of congestion reduction, the more time added to commutes and delivery from congestion, the higher the appetite for autonomous vehicle fleets.

(3) City Operator Metrics or the number of operators for ride hail and delivery companies (594) is also included in the model for AV vehicles in at least one embodiment. Typically, more operators means lower number of vehicles per operator. The following factors may also be considered and included in the model as part of the Citi Operator Metrics (594):

a. Number of taxi companies—more concentrated competitive dynamics means partnering with a single operator will ensure higher volumes.

b. Number of local delivery companies—more concentrated competitive dynamics means partnering with a single operator will ensure higher volumes.

The model automatically evaluates the above-referenced data and constraining factors. Upon completion of the third phase of analysis, the output with a detailed description of the opportunity size for a city and a given combination of cities as they are “activated” in each year may be provided on a display screen or transmitted to a mobile device or computer processor.

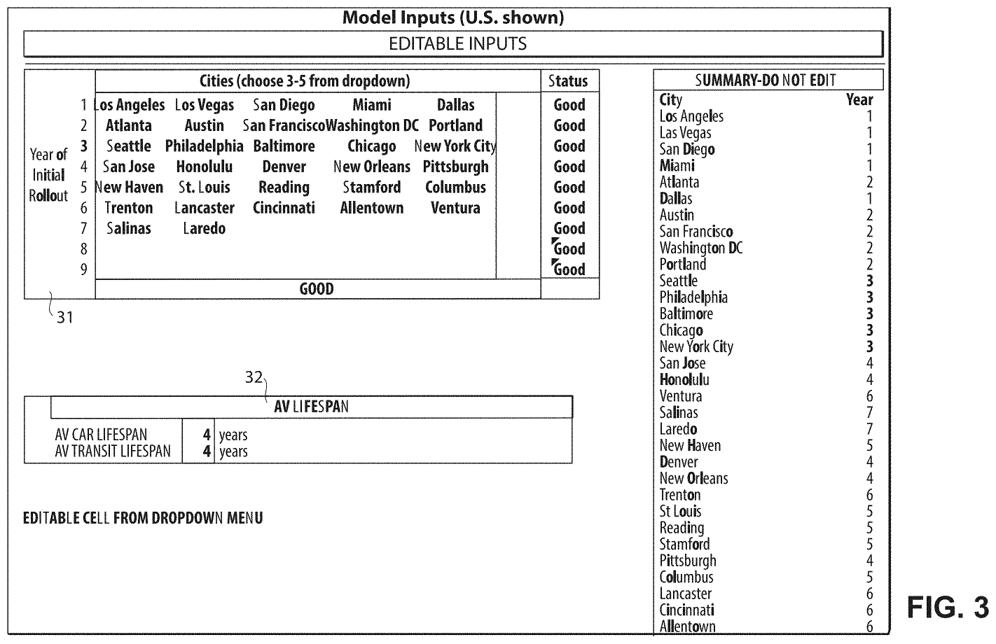

Referring to FIG. 3, the table on the left is the assumed “rollout” that can be altered by the user to determine which city or area is “activated” in a given year and thus changing the total number of autonomous vehicles required to meet opportunity demand. The “AV Lifespan” inputs allow the user to input modified data and change the duration of how long an autonomous vehicle's assumed lifespan would be. The user interface for allowing user selection and modification is shown in FIG. 3. The modification and updated data are automatically processed and evaluated by the computer processor that executes computer instructions in accordance with at least one embodiment. The modified data is processed through and by the model set forth below and may modify the results and the readiness evaluation base on the entered changes.

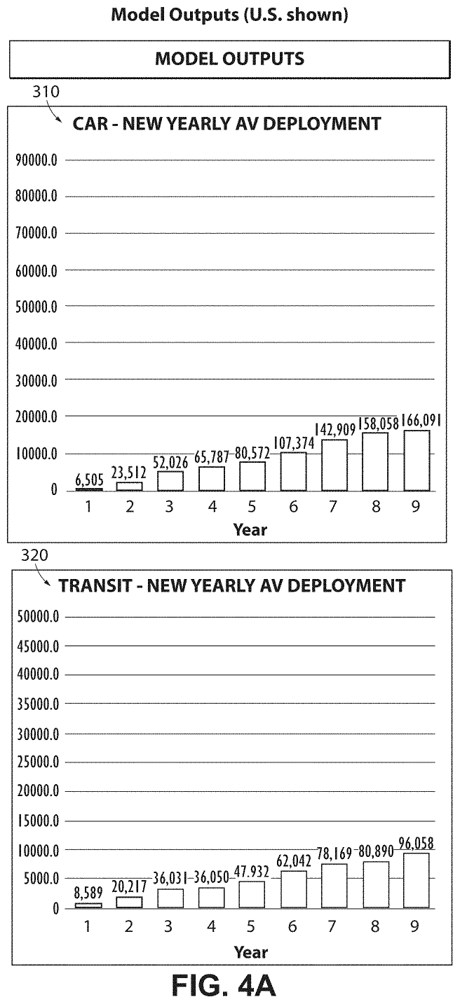

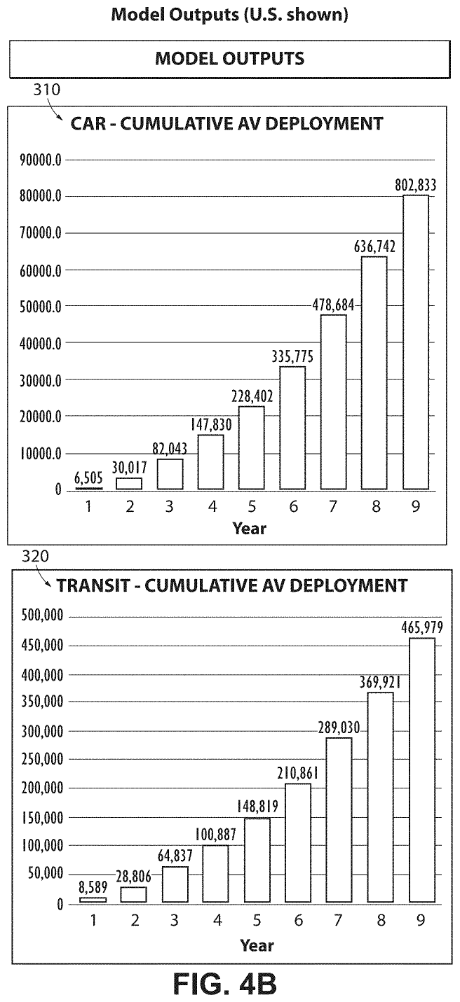

Referring to FIGS. 4A and B, the graphs show both new annual opportunity (FIG. 4A) for cars 410 and transit 420 based on the inputs indicated in FIG. 3, as well as cumulative opportunity (FIG. 4B) for cars 415 and 425, over the 9-year period. They are broken out by car vs. transit in this embodiment as follows:

a) Car
Food Delivery
Taxi
TaaS
Grocery Delivery
Limousine

b) Transit
Transit
Last Mile Delivery
Shuttle Bus

An example of the results of a modeling and automated processing for utilization of autonomous vehicles in the U.S. in accordance with at least one embodiment (where 375 different cities were evaluated), in EU (29 different cities evaluated) and AP (27 different cities evaluated) is provided in Appendix A. It also lists the top cities that are best suited for the autonomous vehicle adoption based on the model evaluation in accordance with at least one embodiment. Various sources that may be utilized for the data, and the “assumptions”, based on the indicated data sources, are used in at least one model for the US, EP and AP cities and locations evaluations for utilization of autonomous vehicles, as listed and indicated in Appendix A. As set forth in the “Assumptions” examples described in Appendix A, the assumptions may be different form different countries and different cities, and the assumptions and calculations may be separated for the vehicles that move people, and vehicles that move goods.

It will be understood by those skilled in the art that each of the above steps or elements of the system will comprise computer-implemented aspects, performed by one or more of the computer components described herein. For example, any or all of the steps of collection, evaluation, processing and modeling of the frustration factors and data may be performed electronically. In at least one exemplary embodiment, all steps may be performed electronically—either by general or special purpose processors implemented in one or more computer systems such as those described herein.

It will be further understood and appreciated by one of ordinary skill in the art that the specific embodiments and examples of the present disclosure are presented for illustrative purposes only, and are not intended to limit the scope of the disclosure in any way.

Accordingly, it will be understood that various embodiments of the present system described herein are generally implemented as a special purpose or general-purpose computer including various computer hardware as discussed in greater detail below. Embodiments within the scope of the present invention also include computer-readable media for carrying or having computer-executable instructions or data structures stored thereon. Such computer-readable media can be any available media which can be accessed by a general purpose or special purpose computer, or downloadable through communication networks. By way of example, and not limitation, such computer-readable media can comprise physical storage media such as RAM, ROM, flash memory, EEPROM, CD-ROM, DVD, or other optical disk storage, magnetic disk storage or other magnetic storage devices, any type of removable non-volatile memories such as secure digital (SD), flash memory, memory stick etc., or any other medium which can be used to carry or store computer program code in the form of computer-executable instructions or data structures and which can be accessed by a general purpose or special purpose computer, or a mobile device.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the invention may be implemented. Although not required, the inventions are described in the general context of computer-executable instructions, such as program modules or engines, as described earlier, being executed by computers in networked environments. Such program modules are often reflected and illustrated by flow charts, sequence diagrams, exemplary displays, and other techniques used by those skilled in the art to communicate how to make and use such computer program modules. Generally, program modules include routines, programs, objects, components, data structures, etc. that perform particular tasks or implement particular abstract data types, within the computer. Computer-executable instructions, associated data structures, and program modules represent examples of the program code for executing steps of the methods disclosed herein. The particular sequence of such executable instructions or associated data structures represent examples of corresponding acts for implementing the functions described in such steps.

Those skilled in the art will also appreciate that the invention may be practiced in network computing environments with many types of computer system configurations, including personal computers, hand-held devices, multi-processor systems, microprocessor-based or programmable consumer electronics, networked PCs, minicomputers, mainframe computers, and the like. The invention is practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the inventions, which is not illustrated, includes a general purpose computing device in the form of a conventional computer, including a processing unit, a system memory, and a system bus that couples various system components including the system memory to the processing unit. The computer will typically include one or more magnetic hard disk drives (also called “data stores” or “data storage” or other names) for reading from and writing to. The drives and their associated computer-readable media provide nonvolatile storage of computer-executable instructions, data structures, program modules, and other data for the computer. Although the exemplary environment described herein employs a magnetic hard disk, a removable magnetic disk, removable optical disks, other types of computer readable media for storing data can be used, including magnetic cassettes, flash memory cards, digital video disks (DVDs), Bernoulli cartridges, RAMs, ROMs, and the like.

Computer program code that implements most of the functionality described herein typically comprises one or more program modules may be stored on the hard disk or other storage medium. This program code, as is known to those skilled in the art, usually includes an operating system, one or more application programs, other program modules, and program data. A user may enter commands and information into the computer through keyboard, pointing device, a script containing computer program code written in a scripting language or other input devices (not shown), such as a microphone, etc. These and other input devices are often connected to the processing unit through known electrical, optical, or wireless connections.

The main computer that effects many aspects of the inventions will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), and wireless LANs (WLAN) that are presented here by way of example and not limitation. Such networking environments are commonplace in office-wide or enterprise-wide computer networks, intranets and the Internet.

When used in a LAN or WLAN networking environment, the main computer system implementing aspects of the invention is connected to the local network through a network interface or adapter. When used in a WAN or WLAN networking environment, the computer may include a modem, a wireless link, or other means for establishing communications over the wide area network, such as the Internet. In a networked environment, program modules depicted relative to the computer, or portions thereof, may be stored in a remote memory storage device. It will be appreciated that the network connections described or shown are exemplary and other means of establishing communications over wide area networks or the Internet may be used.

Calculations and evaluations described herein, and equivalents, are, in an embodiment, performed entirely electronically. Other components and combinations of components may also be used to support processing data or other calculations described herein as will be evident to one of skill in the art. A computer server may facilitate communication of data from a storage device to and from processor(s), and communications to computers. The processor may optionally include or communicate with local or networked computer storage which may be used to store temporary or other information. The applicable software can be installed locally on a computer, processor and/or centrally supported (processed on the server) for facilitating calculations and applications.

In view of the foregoing detailed description of preferred embodiments of the present invention, it readily will be understood by those persons skilled in the art that the present invention is susceptible to broad utility and application. While various aspects have been described in the context of a preferred embodiment, additional aspects, features, and methodologies of the present invention will be readily discernible from the description herein, by those of ordinary skill in the art. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention.

It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the present inventions. In addition, some steps may be carried out simultaneously.

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope. Accordingly, the scope of the present inventions is defined by the appended claims rather than the foregoing description and the exemplary embodiments described therein.

While certain exemplary aspects and embodiments have been described herein, many alternatives, modifications, and variations will be apparent to those skilled in the art. Accordingly, exemplary aspects and embodiments set forth herein are intended to be illustrative, not limiting. Various modifications may be made without departing from the spirit and scope of the disclosure.

### Appendix A

### Examples of Resulting Studies and Modeling Based on at Least One Embodiment

What is claimed is:

1. An automated computerized system for evaluating readiness of one or more geographic locations for employment of autonomous vehicles at the respective geographic locations, comprising:
at least one processor executing a plurality of computer instructions stored in memory, causing the processor to perform:
(1) receiving and automatically processing input data for one or more geographic locations;
(2) evaluating the received input data for one ore more geographic locations based on evaluation of a weather constraint data, a population size constraint data and a speed limit constraint data as part of a first phase of the automated processing and analysis;
(3) evaluating input data for one ore more geographic locations selected after the first phase, wherein the evaluation comprises determining and applying a total food related delivery vehicles data, total ride hail vehicles data, a historic growth rate for each type of vehicle and a turnover rate for each type of vehicle, as part of a second phase of the automated processing and analysis;
(4) evaluating input data for one ore more geographic locations selected after the second phase, wherein the evaluation comprises determining and applying one or more economic indicators, city transportation indicators and city operator metrics, as part of a third phase of the automated processing and analysis;
(5) automatically combining and evaluating the data based on the constraints and indicators of the first, second and third phases and computing results of the evaluations;
(6) providing and displaying a calculated value indicating readiness for the deployment of automated vehicles and a projected implementation timeline for one or more evaluated geographic locations; and
(7) utilizing the calculated value to implement an automated vehicle use or vehicle introduction program in one or more of the evaluated geographic locations.

2. The system of claim 1, wherein the evaluation of the weather constraint data comprises evaluation and selection for further processing of one or more geographic locations that have a higher percentage of days without heavy rain, heavy snow, or fog, based on one or more weather data sources.

3. The system of claim 1, wherein the evaluation of the population constraint data comprises evaluation and selection for further processing of one or more geographic locations that have a higher concentration of human population per square mile and an overall population greater than a minimal set limit, based on one or more census data sources.

4. The system of claim 1, wherein the evaluation of the speed limit constraint data comprises evaluation and selection for further processing of one or more geographic locations wherein at least 90 percent of speed limitations zones within the location are below 45 miles an hour.

5. The system of claim 1, wherein at least one processor executing a plurality of computer instructions stored in memory further causes the processor to reduce the number of evaluated geographic locations after performing the first phase and after the second phase of the automated processing and analysis.

6. The system of claim 1, wherein the food related delivery vehicles data evaluated by the system comprises data related to a grocery, a restaurant, a local and a last mile delivery vehicles.

7. The system of claim 1, wherein the food related delivery vehicles data comprises data for a plurality of vehicle that deliver food from restaurants, and wherein the grocery delivery vehicles data comprises data for a plurality of vehicles that deliver groceries from multiple food stores and supermarkets.

8. The system of claim 6, wherein the last minute vehicles data utilizes a market share of UPS, FedEx, DHL, Amazon and other regional delivery services.

9. The system of claim 1, wherein the ride hail vehicles data evaluated by the system comprises vehicle data pertaining to taxis, TaaS vehicles, limousines and other passenger vehicles, and public transportation that carry multiple passengers.

10. The system of claim 1, further comprising evaluation of data pertaining to autonomous vehicles that are used as food related delivery vehicles or ride hail vehicles, and wherein a lifespan of the autonomous vehicles is set to 4 years of use.

11. The system of claim 1, wherein the turnover rate for at least one type of vehicle is calculated based on a number of vehicles of the same or similar type that are replaced each year.

12. The system of claim 1, wherein the determining and applying the economic indicators includes applying data and analysis of a luxury goods sales and a local shopping sales.

13. The system of claim 1, wherein the determining and applying the city transportation constraints includes applying data and analysis of a vehicle miles travelled, a public transport share of travel and an added travel time from a congestion data and evaluation at the location.

14. The system of claim 1, wherein the determining and applying the city operator metrics includes applying data and analysis of a number of taxi companies and a number of local delivery companies at the location.

15. An automated computerized method for evaluating readiness of one or more geographic locations for employment of autonomous vehicles comprising:
(1) receiving and automatically processing input data for one or more geographic locations;
(2) evaluating the received input data for one ore more geographic locations based on evaluation of a weather constraint data, a population size constraint data and a speed limit constraint data as part of a first phase of the automated processing and analysis;
(3) evaluating input data for one ore more geographic locations selected after the first phase, wherein the evaluation comprises determining and applying a total food related delivery vehicles data, total ride hail vehicles data, a historic growth rate for each type of vehicle and a turnover rate for each type of vehicle, as part of a second phase of the automated processing and analysis;
(4) evaluating input data for one ore more geographic locations selected after the second phase, wherein the evaluation comprises determining and applying an economic indicators, a city transportation indicators, and a city operator metrics, as part of a third phase of the automated processing and analysis;
(5) automatically combining and evaluating the data based on the constraints and indicators of the first, second and third phases and computing results of the evaluations;
(6) providing and displaying a calculated value indicating readiness for the deployment of automated vehicles and a projected implementation timeline for one or more evaluated geographic locations; and
(7) utilizing the calculated value to implement an automated vehicle use or vehicle introduction program in one or more of the evaluated geographic locations.

16. The method of claim 15, wherein the evaluating the weather constraint data comprises evaluating and selecting for further processing one or more geographic locations that have a higher percentage of days without heavy rain, heavy snow, or fog, based on one or more weather data sources.

17. The method of claim 15, wherein the evaluating the population constraint data comprises evaluating and selecting for further processing one or more geographic locations that have a higher concentration of human population per square mile and an overall population greater than a minimal set limit, based on one or more census data sources.

18. The method of claim 15, wherein the evaluating the speed limit constraint data comprises evaluating and selecting for further processing one or more geographic locations where at least 90 percent of speed limitations zones within the location are below 45 miles an hour.

19. The method of claim 15, further comprising: reducing the number of evaluated geographic locations after performing the first phase and after the second phase of the automated processing and analysis.

20. The method of claim 15, wherein the evaluation of food related delivery vehicles data comprises evaluation of data related to a plurality of grocery, restaurant, local and last mile delivery vehicles.

21. The method of claim 15, wherein the evaluation of food related delivery vehicles data comprises evaluation of data related to a plurality of vehicle that deliver food from restaurants, and wherein the grocery delivery vehicles data comprises data for a plurality of vehicles that deliver groceries from multiple food stores and supermarkets.

22. The method of claim 21, wherein the last minute vehicles data utilizes a market share of UPS, FedEx, DHL, Amazon and other regional delivery services.

23. The method of claim 15, wherein the evaluating of the ride hail vehicles data comprises evaluating vehicle data pertaining to taxis, TaaS vehicles, limousines and other passenger vehicles, and public transportation that carry multiple passengers.

24. The method of claim 15, further comprising evaluating data pertaining to a plurality of autonomous vehicles that are used as food related delivery vehicles or ride hail vehicles, and wherein a lifespan of the autonomous vehicles is set to 4 years of use.

25. The method of claim 15, wherein the turnover rate for at least one type of vehicle is calculated based on a number of vehicles of the same or similar type that are replaced each year.

26. The method of claim 16, wherein the determining and applying the economic indicators includes applying data and analysis of a luxury goods sales and a local shopping sales.

27. The method of claim 15, wherein the determining and applying the city transportation constraints includes applying data and analysis of a vehicle miles travelled, a public transport share of travel and an added travel time from a congestion data and evaluation at the location.

28. The method of claim 1, wherein the determining and applying the city operator metrics includes applying data and analysis of a number of taxi companies and a number of local delivery companies at the location.

29. An automated computerized method for evaluating readiness of one or more geographic locations for employment of autonomous vehicles comprising:
(1) receiving at a computer server having one or more processors and connected to a network an input data for one or more geographic locations;
(2) evaluating the received input data for one ore more geographic locations based on evaluation of a weather constraint data, a population size constraint data and a speed limit constraint data as part of a first phase of the automated processing and analysis;
(3) evaluating input data for one ore more geographic locations selected after the first phase, wherein the evaluation comprises determining and applying a total food related delivery vehicles data, total ride hail vehicles data, a historic growth rate for each type of vehicle and a turnover rate for each type of vehicle, as part of a second phase of the automated processing and analysis;
(4) evaluating input data for one ore more geographic locations selected after the second phase, wherein the evaluation comprises determining and applying an economic indicators, a city transportation indicators, and a city operator metrics, as part of a third phase of the automated processing and analysis;
(5) automatically combining and evaluating the data based on the constraints and indicators of the first, second and third phases and computing results of the evaluations;
(6) storing or displaying a calculated value indicating readiness for the deployment of automated vehicles and a projected implementation timeline for one or more evaluated geographic locations; and
(7) transmitting the calculated value to another computer or mobile device;
whereby the transmitted calculated value is utilized to implement an automated vehicle use or vehicle introduction program at one or more of the evaluated geographic locations.
